(19) United States
(12) Patent Application Publication
(10) Pub. No.: US 2010/0253329 A1
(43) Pub. Date: Oct. 7, 2010

(54) System and Apparatus for Automated Inspection of Overhead Electrical Traction Rail Car Pantographs

(76) Inventors: Gianni Arcaini, Jacksonville, FL (US); Larry Strach, Ponte Vedra Beach, FL (US)

Correspondence Address: LAW OFFICE OF L. JACK GIBNEY, 8777 SAN JOSE BLVD., SUITE 502, JACKSONVILLE, FL, 32217, US

(21) Appl. No.: 12/419,501

(22) Filed: Apr. 7, 2009

(51) Int. Cl. B61K 9/00; H04N 7/18

(52) U.S. Cl. 324/217; 348/61; 348/E07.085

(57) ABSTRACT

This invention will provide a quick and safe method to inspect the condition of a pantograph and associated contacts to insure that appropriate contact is maintained and that a light rail car operates with maximum efficiency. Cameras that are capable of operating in low levels of lighting will capture visual images of the pantograph and contacts and relay that information to a remote location for appropriate action. The data concerning the condition of the pantograph may be stored for forensic purposes and routine corrective action.

### BACKGROUND OF THE INVENTION

A. Field of the Invention

Certain light railcars employ pantographs, which are spring-loaded devices that push a contact shoe or brush against a contact wire. The purpose of pushing the shoe or brush against the contact wire is to draw the electricity needed to run the train. One of the inherent problems with this system, however, is that the pantographs must be visually inspected on a daily basis, if not more frequently, for possible damage to the shoe or brush or any other parts of the pantograph. If damage is observed, appropriate remedial action must be taken to insure that the pantograph operates properly.

In order to minimize traffic disruption, inspection typically occurs when the trains are in the station and idle. The great disadvantage of that, however, is that train stations tend to have limited light with confined spaces and the pantographs are on the top of the light rail car and therefore not visible by someone on the ground. These factors, among others, compromise the safety and accuracy of the inspection method in addition to wasting time.

B. Prior Art

There are prior art references to pantographs in general, including remote-controlled mobile inspecting and monitoring systems. This type of device can be found at Takenaka, U.S. Pat. No. 4,661,308. This is a remote-controlled mobile inspecting system. The system is laid along an inspection rail and the system can move up and down the line. The system itself is also connected to power lines and can give a bird's eye view of conditions of a particular pantograph.

Another reference in the prior art is found at Stemmann, U.S. Pat. No. 4,113,034. This is an improved technique for regulating contact pressure of a pantograph brush on an overhead guide conductor. This, however, is not an inspection method but is, in fact, a means to regulate the pressure to regulate the brush contact pressure and extend the life of the pantograph.

### BRIEF SUMMARY OF THE INVENTION

A pantograph is a device that is attached to the top of a light rail car and insures contact with an overhead wire. On one end of the pantograph is a shoe or brush that allows for the transfer of electricity to power the rail car. These light railcars are powered by electricity, which is provided by a upper load carrying wire, which is called a catenary, and positioned some distance above the rail car as part of the pantograph.

Electricity is transferred from the catenary through the shoe or brush to power the rail car by means of this pantograph, which is a spring-loaded device and insures that a set of contacts on one end of the pantograph maintains contact with the overhead wire.

Contacts on the pantograph make direct contact with the overhead wire and permit the transfer of electricity. The pantograph replaced the single pole system to operate light rail cars.

Because the electricity to operate the train or light rail car passes from the overhead wire to the trolley or light rail car, it is imperative that appropriate contact be maintained between the contacts on the pantograph and the overhead wire at all times. It is important to maintain appropriate pressure on the pantographs so that sufficient contact can be maintained to maximize the efficiency of the railcar and insure that the light rail car operates reliably.

Pantographs are typically spring-loaded devices and do not directly contact the wire but provide a conduit for the electricity to pass from the overhead wire to the light rail car propulsion system. Because the operation of the light rail car depends on the proper functioning of the pantograph and associated contacts, it is important to inspect this equipment as frequently as possible and as safely as possible. Typically, inspections occur when trains are in the station and stationary but because the pantographs are located above the light rail car, it is difficult and at times unsafe to obtain a complete and thorough inspection. Additionally limited light and space considerations may also complicate the inspection of the pantograph. When the train or light rail car is moving even at relatively slow speeds, inspection is likely impossible.

In this system high speed cameras that are strategically positioned above the level of the rail car to capture images at various angles can now be used to provide a visual inspection of the pantograph without risking a worker to personal injury. The cameras are designed to operate in very poor lighting conditions and capture high speed images.

The cameras provide a means to provide a visual recording of the pantograph and transfer the visual images that are captured by the cameras to a remote location so that appropriate remedial action, if any is required, may be taken by the user or operator of this particular system. The images may also be stored for forensic purposes as well as corrective maintenance action.

### BRIEF DESCRIPTION OF THE DRAWINGS

FIG. 1 is an isometric overhead view of the components of the system.

### DETAILED DESCRIPTION OF THE EMBODIMENTS

Light rail cars and/or trolley cars 4 are sometimes powered by an overhead electrical transmission device such as wires 6 and travel over a designated track system 3. The electrical wires provide electricity and this electricity must be safely transferred to power the light rail car or trolley that is located below the overhead wire. The overhead wire or wires 6 is called the catenary and the device that allows for the contact between the wire and the trolley or light rail car is called the pantograph 7.

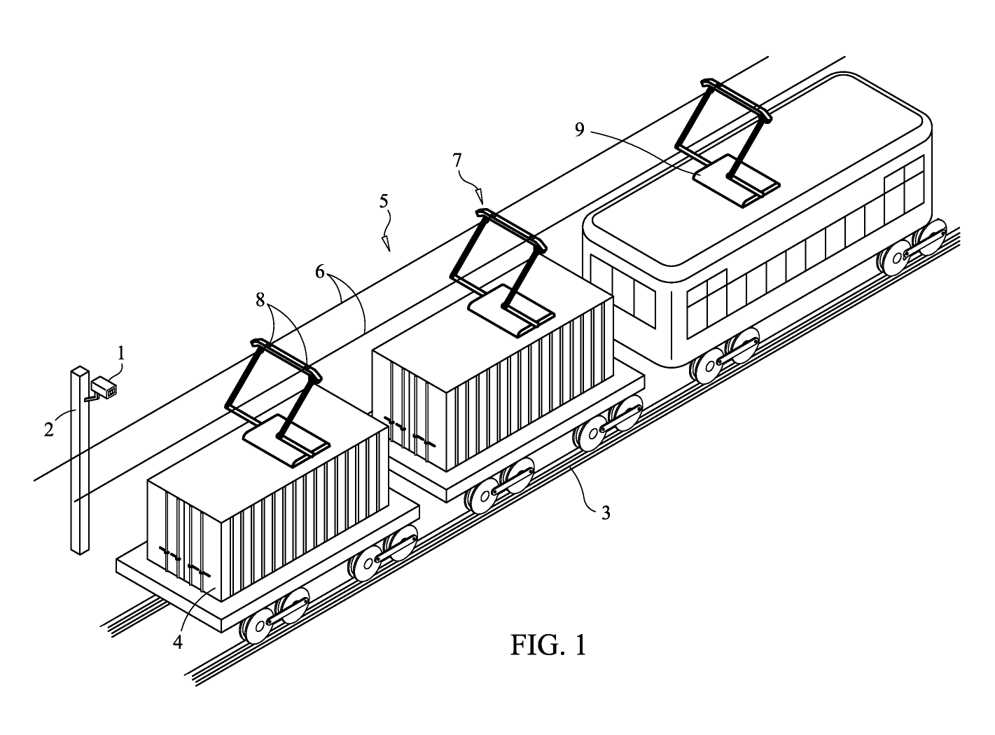

Pantographs 7 can come in many different shapes and sizes, including V and diamond shapes. The pantograph may have a single wire or may have double wires. The particular shape or configuration of the pantograph is not necessarily germane to this invention other than the system will operate effectively on any type of pantograph system. Regardless of the shape of the pantograph 7, a set of contacts, also called a shoe or brush 8, on one end of the pantograph 7 maintains contact with the overhead wire 6 and the other end of the pantograph is connected to the trolley or light rail car propulsion system 9 such as depicted in FIG. 1.

Pantographs 7 are equipped with springs to insure that the contacts of the pantograph are connected at all times to the overhead wires 6.

A set of contacts on the pantograph makes direct contact with the overhead wires through which the electricity to power the light rail car is transferred. Because the proper transfer of electricity to the light rail car occurs through the contacts and pantograph, it is important to maintain that contact and to inspect the condition of the contacts and the pantograph to insure that the appropriate amount of electricity is being transferred to the trolley or light rail car system as effectively as possible.

This particular application is a system and apparatus for the automated inspection of overhead electrical traction rail car pantographs to insure that the conditions of the contacts as well as the general condition of the pantographs is maintained to insure that appropriate current flow is being maintained. Because the pantograph and contacts are above the trolley or light rail car 4, it is physically difficult to inspect the condition of this equipment, particularly if the car is moving, even at slow speeds. Additionally this type of car may operate in tunnels or confined spaces that would make casual visual inspection impossible. There is also the safety concern of exposing a worker to the potential danger when working at heights to inspect equipment that is mounted on a light rail car or trolley and the risk of exposing the worker to large amounts of electricity.

In this system a plurality of cameras 1 are positioned to capture visual images of this equipment with relatively little human interaction. Human interaction in this type of environment may be dangerous and this particular method or system decreases the risk of personal injury greatly.

A plurality of cameras 1 are mounted on structures 2 such as posts or poles that will allow inspection of the top of rail car, probably inside a train or light rail station and at the general level of the contact wires and the top surface of the light rail car. A plurality of cameras is provided to obtain a multitude of views.

The cameras 1 should be able to operate in extremely poor lighting conditions, particularly dim lighting conditions and also have infrared capability. The cameras should also possess the ability to take high speed images at extremely close range and the capability to adjust the camera angle and zoom features.

Multiple cameras 1 should be used in order to obtain as many angles or views as possible to insure that the operator has complete knowledge of the operation of the system. The cameras should be able to capture images at high speeds with excellent resolution.

Once the images are captured, software allows the captured images to be transferred to a remote location and displayed so that an operator can easily view the images of the equipment.

Another feature of the software is to alert the user of the system in the event of a malfunction or probable malfunction and the need for immediate attention. The cameras that are integrated with the software can extract and display either two or three dimensional data or images.

The software will also provide alerts for routine system maintenance. Certain presets will be provided in the system that will alert the user to either an immediate need or a routine maintenance concern. The information that will be used by the software to provide information about the routine maintenance issues or repair issues may be provided by extracted two or three dimensional images or preset sufficiency thresholds.

The information concerning the collection and storage of the data may be stored for forensic purposes as well as maintenance and remedial action.

The inventors claim:

1. A system and apparatus for automated inspection of overhead electrical traction rail car pantographs, which is comprised of:
a. an overhead electrical transmission device;
wherein an overhead electrical transmission device provides electricity for a light rail car;
b. a pantograph;
wherein the pantograph provide a conduit for electricity to travel from the overhead electrical transmission device to the light rail car;
wherein the pantograph has a first end and a second end;
wherein the first end is connected to the light rail car;
wherein a set of contacts is provided on the second end;
wherein the pantograph is spring loaded;
c. contacts;
wherein a set of contacts are provided on the second end of the pantograph;
said contacts maintain contact with the overhead electrical transmission device;
said contacts permit the transfer of electricity from the overhead electrical transmission device to a propulsion system of the light rail car;
d. cameras;
wherein a plurality of cameras are provided;
wherein the cameras are affixed to a structure;
said structure provides access to images of the top surface of the light rail car;
said cameras are positioned to obtain images of the condition of the pantograph and contacts;
wherein the cameras are positioned at predetermined locations;
e. software;
wherein software is provided to transfer the captured images from the cameras;
wherein the software enables a visual display of the captured images at a remote location;
wherein the captured images can be stored;
wherein the software analyzes the captured images;
wherein presets are provided in the software;
said presets alert the user of the system of the system.

2. The system and apparatus for automated inspection of overhead electrical traction rail car pantographs as described in claim 1 wherein the pantograph is diamond shaped.

3. The system and apparatus for automated inspection of overhead electrical traction rail car pantographs as described in claim 1 wherein the pantograph is V shaped.

4. The system and apparatus for automated inspection of overhead electrical traction rail car pantographs as described in claim 1 wherein the pantograph has a single wire.

5. The system and apparatus for automated inspection of overhead electrical traction rail car pantographs as described in claim 1 wherein the pantograph has a double wire.

6. The system and apparatus for automated inspection of overhead electrical traction rail car pantographs as described in claim 1 wherein the cameras have infrared capability.

7. The system and apparatus for automated inspection of overhead electrical traction rail car pantographs as described in claim 1 wherein the cameras can operate in dim lighting conditions.

8. The system and apparatus for automated inspection of overhead electrical traction rail car pantographs as described in claim 1 wherein the cameras operate at high speeds.

9. The system and apparatus for automated inspection of overhead electrical traction rail car pantographs as described in claim 1 wherein the cameras have zoom capability.

10. The system and apparatus for automated inspection of overhead electrical traction rail car pantographs as described in claim 1 wherein the preset factors are determined by extracted two dimensional data.

11. The system and apparatus for automated inspection of overhead electrical traction rail car pantographs as described in claim 1 wherein the preset factors are determined by extracted three dimensional data.

12. The system and apparatus for automated inspection of overhead electrical traction rail car pantographs as described in claim 1 wherein the preset factors are determined by sufficiency thresholds.
